(19) United States
(12) Patent Application Publication
(10) Pub. No.: US 2010/0190015 A1
(43) Pub. Date: Jul. 29, 2010

(54) Organic Polymer Compound, Optical Film and Method of Production Thereof

(75) Inventor: Irina Kasianova, Moscow Region (RU)

Correspondence Address: HOUST CONSULTING (Kont), P.O. BOX 2688, SARATOGA, CA, 95070-0688, US

(73) Assignee: Crysoptix KK, Tokyo (JP)

(21) Appl. No.: 12/628,398

(22) Filed: Dec. 1, 2009

Related U.S. Application Data
(60) Provisional application No. 61/119,879, filed on Dec. 4, 2008.

(51) Int. Cl. B32B 17/10; B05D 5/06; C08G 75/24; B32B 27/00

(52) U.S. Cl. 428/426; 427/162; 528/321; 428/411.1

(57) ABSTRACT

The present invention relates generally to the field of organic chemistry and particularly to the organic polymer compound, optical films for liquid crystal displays and method of production of the films. An isotropic solution or birefringent lyotropic solution of the organic polymer compound is capable of forming a solid optical retardation layer of a negative C-type or Ac-type plate substantially transparent to electromagnetic radiation in the visible spectral range.

### FIELD OF THE INVENTION

The present invention relates generally to the field of organic chemistry and particularly to the optical films for liquid crystal displays.

### BACKGROUND OF THE INVENTION

The liquid crystal display (LCD) technology has made a remarkable progress in the past years. Cellular phones, laptops, monitors, TV sets and even public displays based on LCD panels are presented on the market. The market of LCD is expected to keep growing in the near future and sets new tasks for researchers and manufacturers. One of the key growth sustainers is product quality improvement along with cost reduction.

Growing size of a LCD diagonal, which has already exceeded 100 inch size, imposes stronger restrictions onto the quality of optical components. In case of retardation films, very small color shift and ability to provide higher contrast ratio at wide viewing angles are required for high-quality viewing of large displays.

Nowadays there are still some disadvantages of LCD technology which impact the quality of liquid crystal displays and still make feasible the competitive technologies like plasma display panel (PDP). One of disadvantages is a decrease of contrast ratio at oblique viewing angles. In conventional LCD the viewing angle performance is strongly dependent upon polarizers' performance. Typical LCD comprises two dichroic polarizers crossed at 90°. However, at oblique angles the angle between projections of their axes deviates from 90°, and the polarizers become uncrossed. The light leakage increases with increasing off-axis oblique angle. This results in low contrast ratio at wide viewing angle along the bisector of crossed polarizers. Moreover, the light leakage becomes worse because of the liquid crystal cell placed between crossed polarizers.

Thus, the technological progress poses the task of developing new optical elements based on new materials with controllable properties. In particular, the necessary optical element in modern visual display systems is an optically anisotropic birefringent film that is optimized for the optical characteristics of an individual LCD module.

Various polymer materials are known in the prior art, which are intended for use in the production of optically anisotropic birefringent films. Optical films based on these polymers acquire optical anisotropy through uniaxial extension.

A triacetyl cellulose films are widely used as negative C plates in modern LCD polarizers. However, their disadvantage is related to a low value of birefringence. Thus, thinner films with high retardation value are desired for making displays cheaper and lighter.

Besides the stretching of the amorphous polymeric films, other polymer alignment techniques are known in the art. Thermotropic liquid crystalline polymers (LCP) can provide highly anisotropic films characterized by various types of birefringence. Manufacturing of such films comprises coating a polymer melt or solution on a substrate; for the latter case the coating step is followed by the solvent evaporation. Additional alignment actions are involved as well, such as an application of the electric field, using of the alignment layer or coating onto a stretched substrate. The after-treatment of the coating is set at a temperature at which the polymer exhibits liquid crystalline phase and for a time sufficient for the polymer molecules to be oriented. Examples of uniaxial and biaxial optical films production can be found in patent documents and scientific publications.

In the article by Li et al, Polymer, vol. 38, no. 13, pp. 3223-3227 (1997) the authors noted that some polymers provide optical anisotropy which is fairly independent of film thickness. They described special molecular order of rigid-chain polymers on the substrate. The director of molecules is preferentially in the plane of the substrate and has no preferred direction in the plane as shown in FIG. 1 (prior art). However, the described method has a technological drawback. After applying the solution onto a hot substrate, temperature was controlled at 60° C. to gently evaporate the solvent and dry the film for 60 min. After that the samples were dried at an elevated temperature of 150° C. for 24 h in a vacuum oven to remove any residual solvent. The last step severely restricts the product commercialization and does not allow using the plastic substrate for LCD manufacturing.

Shear-induced mesophase organization of synthetic polyelectrolytes in aqueous solution was described by T. Funaki et al. in Langmuir, vol. 20, 6518-6520 (2004). Poly(2,2′-disulfonylbenzidine terephtalamide (PBDT) was prepared by an interfacial polycondensation reaction according to the procedure known in the prior art. Using polarizing microscopy, the authors observed lyotropic nematic phase in aqueous solutions in the concentration range of 2.8-5.0 wt %. Wide angle X-ray diffraction study indicated that in the nematic state the PBDT molecules show an inter-chain spacing, d, of 0.30-0.34 nm, which is constant regardless of the concentration (2.8-5.0 wt %). The d value is smaller than that of the ordinary nematic polymers (0.41-0.45 nm), suggesting that PBDT rods in the nematic state have a strong inter-chain interaction in the nematic state to form the bundle-like structure despite the electrostatic repulsion of sulfonate anions. In the concentration range from 2 to 2.8 wt % a shear-induced birefringent (SIB) mesophase was observed.

A number of rigid rod water-soluble polymers was described by N. Sarkar and D. Kershner in Journal of Applied Polymer Science, Vol. 62, pp. 393-408 (1996). The authors suggest using these polymers in different applications such as enhanced oil recovery. For these applications, it is essential to have a water soluble shear stable polymer that can possess high viscosity at very low concentration. It is known that rigid rod polymers can be of high viscosity at low molecular weight compared with the traditionally used flexible chain polymers such a hydrolyzed poly-acrylamides. New sulfonated water soluble aromatic polyamides, polyureas, and polyimides were prepared via interfacial or solution polymerization of sulfonated aromatic diamines with aromatic dianhydrides, diacid chlorides, or phosgene. Some of these polymers had sufficiently high molecular weight (<200 000 according to GPC data), extremely high intrinsic viscosity (˜65 dL/g), and appeared to transform into a helical coil in salt solution. These polymers have been evaluated in applications such as thickening of aqueous solutions, flocculation and dispersion stabilization of particulate materials, and membrane separation utilizing cast films.

The present invention provides solutions to the above referenced disadvantages of the optical films for liquid crystal display or other applications, and discloses a new type of optical film, in particular, a uniaxial negative C-type plate and a biaxial A_{C}-type plate retardation layer, based on water-soluble rigid-core polymers and copolymers.

### SUMMARY OF THE INVENTION

The present invention provides an organic polymer compound of the general structural formula I:

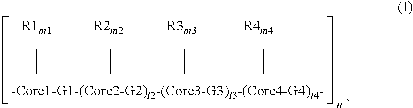

comprising n organic units, wherein the organic unit comprises conjugated organic components Core1, Core2, Core3 and Core4 capable of forming a rigid rod-like macromolecule; G1, G2, G3 and G4 are spacers selected from the list comprising —C(O)—NH—, —NH—C(O)—, —N═(C(O))2=, —O—NH—, linear and branched (C1-C4)alkylenes, linear and branched (C1-C4)alkenylenes, —O—CH2-, —CH2-O—, —CH═CH—, —CH═CH—C(O)O—, —O(O)C—CH═CH—, —C(O)—CH2-, —OC(O)—O—, —OC(O)—, —C≡C—, —C(O)S—, —S—, —S—C(O)—, —O—, —NH—, —N(CH3)-; R1, R2, R3 and R4 are lyophilic side-groups providing solubility to the organic polymer compound or its salts in a suitable solvent and which are the same or different and independently selected from the list comprising —COOH, —SO₃H, and —H₂PO₃ for water or water-miscible solvent, and linear and branched (C1-C20)alkyl, (C2-C20)alkenyl, and (C2-C20)alkinyl for organic solvent; m1, m2, m3 and m4 are numbers of the lyophilic side-groups R1, R2, R3 and R4 in the conjugated organic components Core1, Core2, Core3 and Core4 respectively which sum m=m1+m2+m3+m4 is equal to 0, 1, 2, 3, 4, 5, 6, 7, or 8; t2, t3 and t4 are numbers which are independently selected between 0 and 1, and a solution of the organic polymer compound is capable of forming a solid optical retardation layer of a negative C-type or Ac-type plate substantially transparent to electromagnetic radiation in the visible spectral range.

In a further aspect, the present invention provides an optical film comprising a substrate having front and rear surfaces, and at least one solid retardation layer on the front surface of the substrate. Said solid retardation layer comprises an organic polymer compound of the general structural formula I:

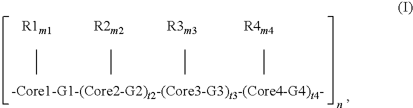

comprising n organic units. The organic unit comprises conjugated organic components Core1, Core2, Core3 and Core4 capable of forming a rigid rod-like macromolecule. G1, G2, G3 and G4 are spacers selected from the list comprising —C(O)—NH—, —NH—C(O)—, —N═(C(O))2=, —O—NH—, linear and branched (C1-C4)alkylenes, linear and branched (C1-C4)alkenylenes, —O—CH2-, —CH2-O—, —CH═CH—, —CH═CH—C(O)O—, —O(O)C—CH═CH—, —C(O)—CH2-, —OC(O)—O—, —OC(O)—, —C≡C—, —C(O)—S—, —S—, —S—C(O)—, —O—, —NH—, —N(CH3)-. R1, R2, R3 and R4 are lyophilic side-groups providing solubility to the organic polymer compound or its salts in a suitable solvent and which are the same or different and independently selected from the list comprising —COOM, —SO₃M, —HMPO₃ and -M₂PO₃ for water or water-miscible solvent where counterion M is selected from a list comprising H⁺, Na⁺, K⁺, Li⁺, Cs⁺, Ba²⁺, Ca²⁺, Mg²⁺, Sr²⁺, Pb²⁺, Zn²⁺, La³⁺, Ce³⁺, Y³⁺, Yb³⁺, Gd³⁺, Zr⁴⁺ and NH₄₋ₖQₖ⁺, where Q is independently selected from the list comprising linear and branched (C1-C20)alkyl, (C2-C20)alkenyl, (C2-C20)alkinyl, and (C6-C20)arylalkyl, and k is 0, 1, 2, 3 or 4. The parameters m1, m2, m3 and m4 are numbers of the lyophilic side-groups R1, R2, R3 and R4 in the conjugated organic components Core1, Core2, Core3 and Core4 respectively which sum m=m1+m2+m3+m4 is equal to 0, 1, 2, 3, 4, 5, 6, 7, or 8. The parameters t2, t3 and t4 are numbers which are independently selected between 0 and 1. The solid optical retardation layer is a negative C-type or Ac-type plate substantially transparent to electromagnetic radiation in the visible spectral range.

In yet further aspect, the present invention provides a method of producing an optical film, comprising the following steps: a) preparation of a solution of an organic polymer compound of the general structural formula I or a salt thereof:

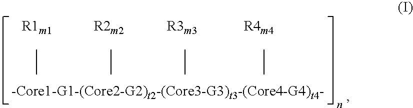

comprising n organic units, wherein the organic unit comprises conjugated organic components Core1, Core2, Core3 and Core4 capable of forming a rigid rod-like macromolecule; G1, G2, G3 and G4 are spacers selected from the list comprising —C(O)—NH—, —NH—C(O)—, —N═(C(O))2=, —O—NH—, linear and branched (C1-C4)alkylenes, linear and branched (C1-C4)alkenylenes, —O—CH2-, —CH2-O—, —CH═CH—, —CH═CH—C(O)O—, —O(O)C—CH═CH—, —C(O)—CH2-, —OC(O)—O—, —OC(O)—, —C≡C—, —C(O)—S—, —S—, —S—C(O)—, —O—, —NH—, —N(CH₃)—. R1, R2, R3 and R4 are lyophilic side-groups providing solubility to the organic polymer compound or its salts in a suitable solvent and which are the same or different and independently selected from the list comprising —COOH, —SO₃H, and —H₂PO₃ for water or water-miscible solvent, and linear and branched (C1-C20) alkyl, (C2-C20) alkenyl, and (C2-C20)alkinyl for organic solvent; the parameters m1, m2, m3 and m4 are numbers of the lyophilic side-groups R1, R2, R3 and R4 in the conjugated organic components Core1, Core2, Core3 and Core4 respectively which sum m=m1+m2+m3+m4 is equal to 0, 1, 2, 3, 4, 5, 6, 7, or 8; and the parameters t2, t3 and t4 are numbers which are independently selected between 0 and 1; b) application of a liquid layer of the solution onto a substrate, wherein the liquid layer is substantially transparent for electromagnetic radiation in the visible spectral range; and c) drying to form a solid optical retardation layer, wherein during the drying step there is a fast increase of a viscosity of the solution without mesophase formation.

### BRIEF DESCRIPTION OF THE DRAWINGS

FIG. 1 (prior art) schematically illustrates the arrangement of rigid chain polymer molecules on a substrate;

FIG. 2 shows the absorbance spectrum of 2,2′-disulfo-4,4′-benzidine terephthalamide-isophthalamide copolymer cesium salt; terephthalamide/isophthalamide molar ratio in the copolymer 50:50;

FIG. 3 shows the absorbance spectrum of poly(2,2′disulpho-4,4′benzidine 1,4,5,8-naphtalen tetracarboxylic acid diimid) triethylammonium salt;

FIG. 4 shows the principal refractive indices' spectra of the organic retardation layer prepared with poly(2,2′-disulfo-4,4′-benzidine isophthalamide) cesium salt on a glass substrate;

FIG. 5 shows the principal refractive indices' spectra of the organic retardation layer prepared with 2,2′-disulfo-4,4′-benzidine terephthalamide-isophthalamide copolymer cesium salt on a glass substrate; terephthalamide/isophthalamide molar ratio in the copolymer 50:50;

FIG. 6 shows the viscosity vs. shear rate dependence of 2,2′-disulfo-4,4′-benzidine terephthalamide-isophthalamide copolymer cesium salt aqueous solution; terephthalamide/isophthalamide molar ratio in the copolymer 50:50;

FIG. 7 shows the principal refractive indices' spectra of the organic retardation layer prepared with 2,2′-disulfo-4,4′-benzidine terephthalamide-isophthalamide copolymer cesium salt on a glass substrate; terephthalamide/isophthalamide molar ratio in the copolymer 75:25;

FIG. 8 shows a polarizing microscopy image of the lyotropic liquid crystal solution texture of 2,2′-disulfo-4,4′-benzidine terephthalamide-isophthalamide copolymer cesium salt (concentration is approximately 6 wt. %); terephthalamide/isophthalamide molar ratio in the copolymer 92:8;

FIG. 9 shows a polarizing microscopy image of the optical film comprising solid optical retardation layer produced with Mayer rod coating method and comprising2,2′-disulfo-4,4′-benzidine terephthalamide-isophthalamide copolymer cesium salt; terephthalamide/isophthalamide molar ratio in the copolymer 92:8;

FIG. 10 shows the principal refractive indices spectra of the organic retardation layer prepared with 2,2′-disulfo-4,4′-benzidine terephthalamide-isophthalamide copolymer cesium salt on a glass substrate; terephthalamide/isophthalamide molar ratio in the copolymer 92:8; and

FIG. 11 shows the principal refractive indices spectra of the organic retardation layer prepared with poly(2,2′disulpho-4,4′ benzidine 1,4,5,8-naphtalen tetracarboxylic acid diimid) triethylammonium/lithium salt on a glass substrate.

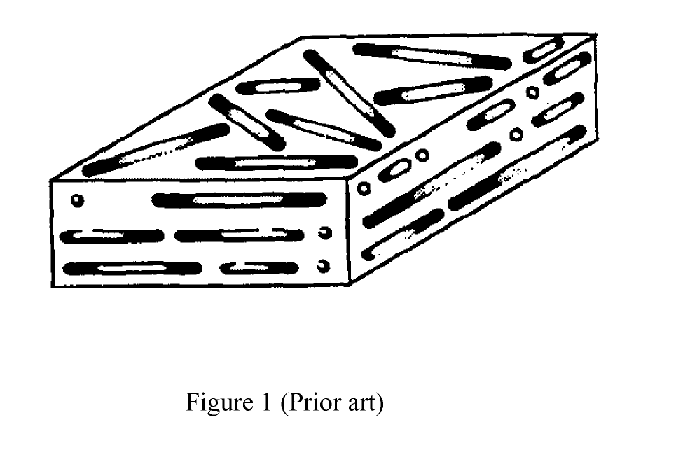

### DETAILED DESCRIPTION OF THE INVENTION

The general description of the present invention having been made, a further understanding can be obtained by reference to the specific preferred embodiments, which are given herein only for the purpose of illustration and are not intended to limit the scope of the appended claims.

Definitions of various terms used in the description and claims of the present invention are listed below.

The term “visible spectral range” refers to a spectral range having the lower boundary approximately equal to 400 nm, and upper boundary approximately equal to 700 nm.

The term “retardation layer” refers to an optically anisotropic layer which is characterized by three principal refractive indices (nₓ, n_{y} and n_{z}), wherein two principal directions for refractive indices nₓ and n_{y} belong to xy-plane coinciding with a plane of the retardation layer and one principal direction for refractive index (n_{z}) coincides with a normal line to the retardation layer.

The term “optically anisotropic biaxial retardation layer” refers to an optical layer which refractive indices nₓ, n_{y}, and n_{z} obey the following condition in the visible spectral range: nₓ≠n_{z}≠n_{y}.

The term “optically anisotropic retardation layer of A_{C}-type” refers to an optical layer which refractive indices nₓ, n_{y}, and n_{z} obey the following condition in the visible spectral range: n_{z}<n_{y}<nₓ.

The term “optically anisotropic retardation layer of negative C-type” refers to an optical layer which refractive indices nₓ, n_{y}, and n_{z} obey the following condition in the visible spectral range: n_{z}<nₓ=n_{y}.

The term “NZ-factor” refers to the quantitative measure of degree of biaxiality which is calculated as follows:

$$NZ = \frac{Max ( {n}_{x} , {n}_{y} ) - {n}_{z}}{Max ( {n}_{x} , {n}_{y} ) - Min ( {n}_{x} , {n}_{y} )}$$

The above mentioned definitions are invariant to rotation of system of coordinates (of the laboratory frame) around of the vertical z-axis for all types of anisotropic layers.

As used herein, a “front substrate surface” refers to a surface facing a viewer. A “rear substrate surface” refers to the surface opposite to the front surface.

The present invention provides an organic polymer compound as disclosed hereinabove. In one embodiment of the disclosed organic polymer compound, the organic components Core1, Core2, Core3 and Core4 provide linearity and rigidity of the macromolecule, and the organic components, the sets of lyophilic side groups Rₘ and the number of the organic units n control a ratio between mesogenic properties and viscosity of the solution. The selection of organic components Core1, Core2, Core3 and Core4, the lyophilic side-groups R1, R2, R3 and R4 and number of organic units n determines the type and birefringence of the optical film.

In one embodiment of the disclosed organic polymer compound, the number of the organic units in the rigid rod-like macromolecule n is an integer in the range from 5 to 1000.

In another embodiment of the disclosed organic polymer compound, the organic units are the same. In yet another embodiment of the disclosed organic polymer compound, at least one said organic unit is different and the copolymer is formed.

In still another embodiment of the present invention, the organic components Core1, Core2, Core3 and Core4 are having general structural formulas independently selected from the list comprising general formulas II to VIII shown in Table 1.

TABLE 1
Examples of the structural formulas of conjugated organic components
Core1, Core2, Core3 and Core4.

| | |
|---|---|
| 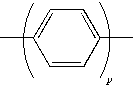 | (II) |
| 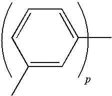 | (III) |
| 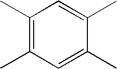 | (IV) |
| 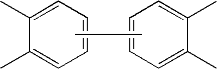 | (V) |
| 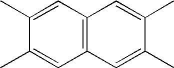 | (VI) |
| 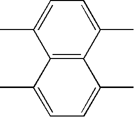 | (VII) |
| 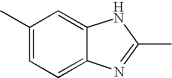 | (VIII) |

where p is equal to 1, 2, 3, 4, 5 or 6.

In still another embodiment a composition is provided which comprises an organic polymer compound of the structural formula I, where t₂ is equal to 1, t₃=t₄=0, m1=0 and m2=2, Core1 is selected from the general formulas II, III, where p=1, V, VII and VIII; the organic component Core2 has the general formula II, where p=2, the lyophilic side-group R2 is sulfo-group SO₃H; the spacer G1 is selected from the list comprising C(O)—NH— and =2(C(O))═N—; and the spacer G2 is selected from the list comprising —C(O)—, —NH—C(O)—, —N═(C(O))2=. Examples of the organic polymer compound are shown in Table 2 including the structural formulas 1 to 6.

TABLE 2
Examples of the structural formulas of the organic compounds according to the
present invention.

| | |
|---|---|
| 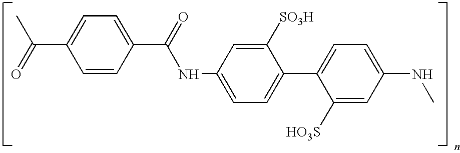 poly(2,2′-disulfo-4,4′-benzidine terephthalamide) | (1) |
| 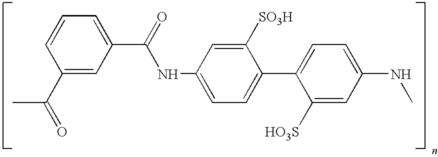 poly(2,2′-disulfo-4,4′-benzidine isophthalamide) | (2) |
| 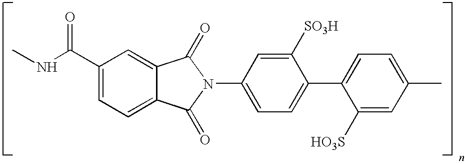 poly(2,2′-disulfo-4,4′-benzidine 1,3-dioxo-isoindoline-5-carboxamide) | (3) |
| 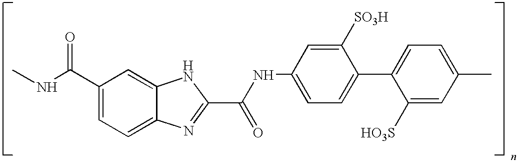 poly(2,2′-disulfo-4,4′-benzidine 1H-benzimidazole-2,5-dicarboxamide) | (4) |
| 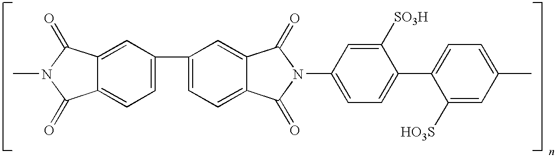 poly(2,2′-disulfo-4,4′-benzidine 3,3′,4,4′-biphenyl tetracarboxylic acid diimide) | (5) |
| 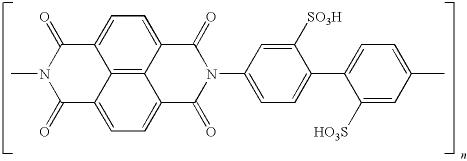 poly(2,2′disulpho-4,4′benzidine 1,4,5,8-naphtalen tetracarboxylic acid diimide) | (6) |

In one embodiment of the disclosed organic polymer compound, the salt of the organic polymer compound is selected from the list comprising alkaline metal salts, ammonium and alkyl-substituted ammonium salts. In another embodiment of the disclosed organic polymer compound, the solvent is selected from the list comprising water, alkaline aqueous solutions, dimethylsulfoxide, dimethylformamide, dimethylacetamide, tetrahydrofurane, dioxane, and combination thereof.

The present invention also provides the optical film as disclosed hereinabove. In one embodiment of the disclosed optical film, the retardation layer type and birefringence are determined by rigidity and length of the rod-like macromolecules, and the ratio between mesogenic properties and the viscosity of the solution are controlled by selection of the organic components Core1, Core2, Core3 and Core4, the lyophilic side-groups R1, R2, R3 and R4 and the number of the organic units n. In one embodiment of the disclosed optical film, the retardation layer birefringence is not less than approximately 0.01. In another embodiment of the disclosed optical film, the number of the organic units in the rigid rod-like macromolecule n is an integer in the range from 5 to 1000. In still another embodiment of the disclosed optical film, the organic units are the same. In yet another embodiment of the disclosed optical film, at least one said organic unit is different and the copolymer is formed.

In still another embodiment of the optical film, the organic components Core1, Core2, Core3 and Core4 are having general structural formulas independently selected from the list comprising general formulas II, VIII shown in Table 1. In still another embodiment of the disclosed optical film, the organic polymer compound has a structural formula I, where t₂ is equal to 1, t₃=t₄=0, m1=0 and m2=2; the organic component Core1 is selected from the general formulas II, III, where p=1, V, VII and VIII; the organic component Core2 has the general formula II, where p=2, the lyophilic side-group R2 is sulfo-group SO₃H; the spacer G1 is selected from the list comprising —C(O)—NH— and =2(C(O))═N—; and the spacer G2 is selected from the list comprising —C(O)—, —NH—C(O)—, —N═(C(O))2=. The examples of the structural formulas of the organic polymer compound are shown in Table 2.

In one embodiment of the disclosed optical film, the salt of the organic polymer compound is selected from the list comprising alkaline metal salts, triethylammonium salt and ammonium salt. In another embodiment of the present invention, the disclosed optical film further comprises inorganic compounds which are selected from the list comprising hydroxides and salts of alkaline metals. In one embodiment of the disclosed optical film, the solid retardation layer is an uniaxial retardation layer possessing two refractive indices (nₓ and n_{y}) corresponding to two mutually perpendicular directions in the plane of the substrate and one refractive index (n_{z}) in the normal direction to the plane of the substrate, and wherein the refractive indices obey the following condition: n_{z}<nₓ=n_{y}. In another embodiment of the disclosed optical film, the solid retardation layer is a biaxial retardation layer possessing two refractive indices (nₓ and n_{y}) corresponding to two mutually perpendicular directions in the plane of the substrate and one refractive index (n_{z}) in the normal direction to the plane of the substrate, and wherein the refractive indices obey the following condition: n_{z}<n_{y}<nₓ. In yet another embodiment of the disclosed optical film, the substrate comprises material selected from the list comprising polymer and glass.

The present invention provides also the method of producing the optical film as disclosed hereinabove. In one embodiment of the disclosed method, the organic components Core1, Core2, Core3 and Core4 provide linearity and rigidity of the macromolecule, and the organic components, the lyophilic side groups and the number of the organic units control a ratio between mesogenic properties and viscosity of the solution. The selection of organic components Core1, Core2, Core3 and Core4, the lyophilic side-groups R1, R2, R3 and R4 and the number of orgabic units n determines the type and birefringence of the optical film.

In one embodiment of the disclosed method, the number of the organic units in the rigid rod-like macromolecule n is an integer in the range from 5 to 1000.

In another embodiment of the disclosed method, the organic units are the same. In yet another embodiment of the disclosed method, at least one said organic unit is different and the copolymer is formed.

In still another embodiment of the method, the organic components Core1, Core2, Core3 and Core4 are having general structural formulas independently selected from the list comprising general formulas II to VIII shown in Table 1,

In one embodiment of the disclosed method, the organic polymer compound has a structural formula I, where t₂ is equal to 1, t₃=t₄=0, m1=0 and m2=2; the organic component Core1 is selected from the general formulas II, III (with p=1), V, VII and VIII; the organic component Core2 has the general formula II (with p=2), the lyophilic side-group R2 is sulfo-group SO₃H; the spacer G1 is selected from the list comprising —C(O)—NH— and =2(C(O))═N—; and the spacer G2 is selected from the list comprising —C(O)—, —NH—C(O)—, —N═(C(O))2= and wherein the organic polymer compound is selected from the structural formulas 1 to 6 shown in Table 2.

In one embodiment of the disclosed method, the salt of the organic polymer compound is selected from the list comprising alkaline metal salts, triethylammonium salt and ammonium salt. In another embodiment of the disclosed method, the substrate comprising material is selected from the list comprising polymer and glass. In yet another embodiment of the present invention, the disclosed method further comprises a post-treatment step comprising a treatment of the layer with a solution of any water-soluble inorganic salt with a cation selected from the list comprising H⁺, Ba²⁺, Pb²⁺, Ca²⁺, Mg²⁺, Sr²⁺, La³⁺, Zn²⁺, Zr⁴⁺, Ce³⁺, Y³⁺, Yb³⁺, Gd³⁺ and any combination thereof. In another embodiment of the disclosed organic polymer compound, the solvent is selected from the list comprising water, alkaline aqueous solutions, dimethylsulfoxide, dimethylformamide, dimethylacetamide, tetrahydrofurane, dioxane, and combination thereof.

In one embodiment of the disclosed method, the application step is carried out using coating technique selected from the list comprising Mayer rod, slot die, extrusion, roll coating, knife coating, spray-coating, printing and molding. In another embodiment of the disclosed method, the sequence of the method steps is repeated two or more times and the solution used in the fabrication of each subsequent solid retardation layer is either the same or different from that used in the previous sequence of the steps.

In order that the invention may be more readily understood, reference is made to the following examples, which are intended to be illustrative of the invention, but are not intended to be limiting the scope.

### EXAMPLES

### Example 1

This example describes synthesis of poly(2,2′-disulfo-4,4′-benzidine isophthalamide) cesium salt (structure 2 in Table 2).

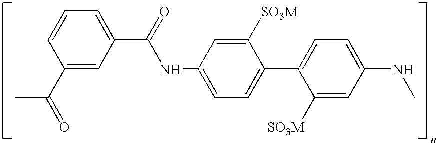

1.377 g (0.004 mol) of 4,4′-diaminobiphenyl-2,2′-disulfonic acid was mixed with 1.2 g (0.008 mol) of Cesium hydroxide monohydrate and 40 ml of water and stirred with dispersing stirrer till dissolving. 0.672 g (0.008 mol) of sodium bicarbonate was added to the solution and stirred. While stirring the obtained solution at high speed (2500 rpm) a solution of 0.812 g (0.004 mol) of isophthaloyl dichloride (IPC) in dried toluene (15 mL) was gradually added within 5 minutes. The stirring was continued for 5 more minutes, and viscous white emulsion was formed. Then the emulsion was diluted with 40 ml of water, and the stirring speed was reduced to 100 rpm. After the reaction mass has been homogenized the polymer was precipitated via adding 250 ml of acetone. Fibrous sediment was filtered and dried.

Weight average molar mass of the polymer samples was determined by gel permeation chromatography (GPC) analysis of the sample was performed with Hewlett Packard (HP) 1050 chromatographic system. Eluent was monitored with diode array detector (DAD HP 1050 at 305 nm). The GPC measurements were performed with two columns TSKgel G5000 PWXL and G6000 PWXL in series (TOSOH Bioscience, Japan). The columns were thermostated at 40° C. The flow rate was 0.6 mL/min. Poly(sodium-p-styrenesulfonate) was used as GPC standard. Varian GPC software Cirrus 3.2 was used for calculation of calibration plot, weight-average molecular weight, Mw, number-average molecular weight, Mn, and polydispersity (D=Mw/Mn). The eluent was mixture of 0.1 M phosphate buffer (pH=7.0) and acetonitrile in the ratio 80/20, respectively. The Mw, Mn, and polydispersity (D) of polymer were 720 000, 80 000, and 9, respectively.

### Example 2

Example 2 describes synthesis of 2,2′-disulfo-4,4′-benzidine terephthalamide-isophthalamide copolymer cesium salt (copolymer of structures 1 and 2 in Table 2).

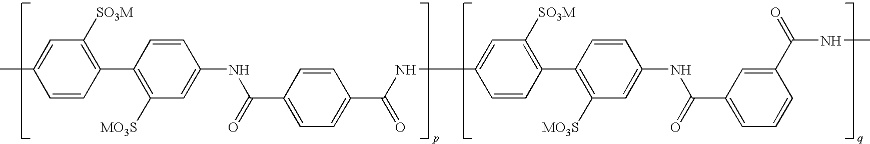

The same method of synthesis can be used for preparation of the copolymers of different molar ratio.

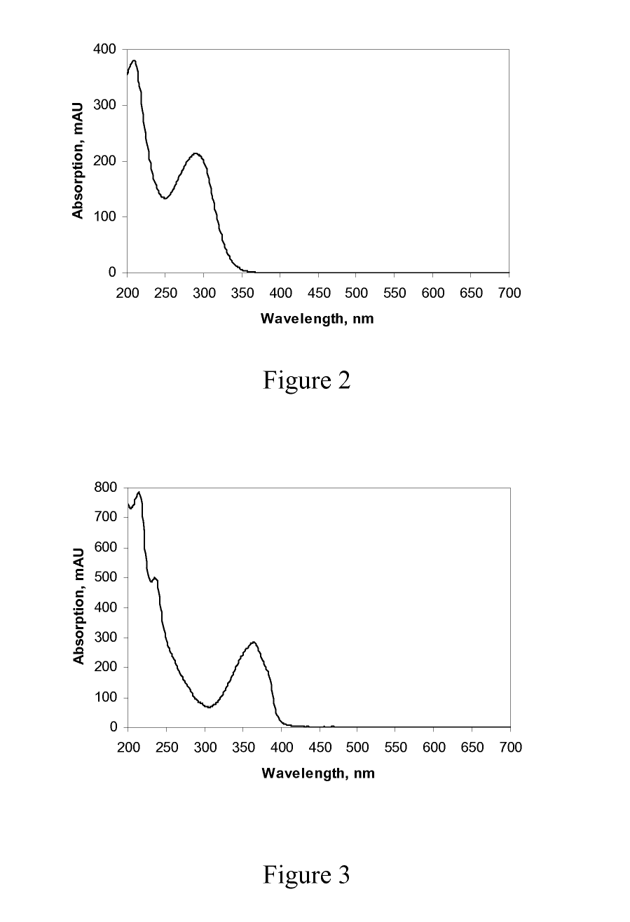

4.098 g (0.012 mol) of 4,4′-diaminobiphenyl-2,2′-disulfonic acid was mixed with 4.02 g (0.024 mol) of cesium hydroxide monohydrate in water (150 ml) in a 1 L beaker and stirred until the solid was completely dissolved. 3.91 g (0.012 mol) of sodium carbonate was added to the solution and stirred at room temperature until dissolved. Then toluene (25 ml) was added. Upon stirring the obtained solution at 7000 rpm, a solution of 2.41 g (0.012 mol) of terephthaloyl chloride (TPC) and 2.41 g (0.012 mol) of isophthaloyl chloride (IPC) in toluene (25 ml) were added. The resulting mixture thickened in about 3 minutes. The stirrer was stopped, 150 ml of ethanol was added, and the thickened mixture was crushed with the stirrer to form slurry suitable for filtration. The polymer was filtered and washed twice with 150-ml portions of 90% aqueous ethanol. Obtained polymer was dried at 75° C. The material was characterized with absorbance spectrum presented at FIG. 2. The GPC molecular weight analysis of the sample was performed as described in Example 1.

### Example 3

Example 3 describes synthesis of poly(2,2′disulpho-4,4′ benzidine 1,4,5,8-naphtalen tetracarboxylic acid diimid) triethylammonium salt (structure 6 in Table 2).

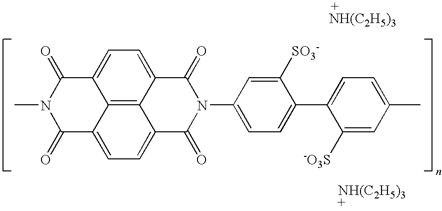

4.023 g (0.015 mol) of 1,4,5,8-naphtaline tetracarbonic acid dianhydride and 5.165 g (0.015 mol) of 2,2′-disulfobenzidine and 0.6 g of benzoic acid (catalyst) are charged into a three-neck flask equipped with an agitator and a capillary tube for argon purging. With argon flow turned on 40 ml of molten phenol is added to the flask. Then the flask is placed in a water bath at 80° C., and the content is agitated until homogeneous mixture is obtained. 4.6 ml of triethylamine is added to the mixture, and agitation is kept on for 1 hour to yield solution. Then temperature is raised successively to 100, 120, and 150° C. At 100 and 120 centigrade agitation is held for 1 hour at each temperature. During this procedure the solution keeps on getting thicker. Time of agitation at 150° C. is 4 to 6 hrs.

The thickened solution is diluted with liquid phenol (mixture of water/phenol=1/10 by volume), until target consistency at 100° C. is obtained, and the resulting mixture is quenched with acetone. The material was characterized with absorbance spectrum shown in FIG. 3.

Weight average molar mass of the polymer samples was determined by gel permeation chromatography (GPC). The GPC analysis of the polymer samples was performed with Hewlett Packard 1050 HPLC system, and with the diode array detector (λ=380 nm). The chromatographic separation was done using OHpak SB-804 HQ column from Shodex. Mixture of dimethyl sulfoxide (DMSO) and dimethylformamide (DMF) in proportion of (75:25) respectively, with addition of 0.05M of lithium chloride (LiCl) was used as the mobile phase. Chromatographic data were collected and processed using the ChemStation B10.03 (Agilent Technologies) and GPC software Cirrus 3.2 (Varian). Poly(styrenesulfonic acid) sodium salt was used as a GPC standard. Before the GPC analysis all samples of the analyzed polymer and the standards were dissolved in DMSO in the concentration of approximately 1 mg/mL.

### Example 4

Example 4 describes synthesis of poly(2,2′-disulfo-4,4′-benzidine 1,3-dioxo-isoindoline-5-carboxamide) cesium salt (structure 3 in Table 2).

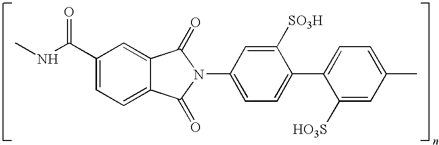

2,5-Diaminobenzene-1,4-disulfonic acid (0.688 g, 2.0 mmol), anhydrous N-methylpyrrolidone (10 mL), triethylamine (0.86 mL) and trimellitic anhydride chloride (0.421 g, 2 mmol) were charged subsequently into a two-neck flask equipped with a magnetic stirrer, thermometer and air condenser with argon inlet. The reaction mixture was then heated up to approximately 130-140° C. and stirred for 24 hours. Then the reaction mixture was cooled to room temperature and the product was coagulated by slowly dripping the mixture into isopropanol with stirring by magnetic stirrer. The precipitate was collected by vacuum filtration and then suspended in methanol (50 mL) and filtered off. The brown solid was air dried for several hours and then vacuum dried at ±60° C. for 2 hours under P₂O₅ to constant weight 0.16 g.

Weight average molar mass of the polymer samples was determined by gel permeation chromatography (GPC). The GPC analysis of the polymer samples was performed with Hewlett Packard 1050 HPLC system, and with the diode array detector (λ=230 nm). The chromatographic separation was done using the TSKgel lyotropic G5000 PW_{XL} column, (TOSOH Bioscience). Mixture of phosphate buffer 0.1 M (pH=6.9-7.0) and acetonitrile was used as the mobile phase. Chromatographic data were collected and processed using the ChemStation B10.03 (Agilent Technologies) and GPC software Cirrus 3.2 (Varian). Poly(styrenesulfonic acid) sodium salt was used as a GPC standard.

### Example 5

Example 5 describes preparation of a solid optical retardation layer of negative C-type from a solution of poly(2,2′-disulfo-4,4′-benzidine isophthalamide).

2 g of poly(2,2′-disulfo-4,4′-benzidine isophthalamide) cesium salt produced as described in Example 1 was dissolved in 100 g of de-ionized water (conductivity ˜5 μSm/cm); the suspension was mixed with a magnet stirrer. After dissolving, the solution was filtered at the hydrophilic filter of a 45 μm pore size and evaporated to the viscous isotropic solution of concentration of solids of about 6%.

Fisher brand microscope glass slides were prepared for coating by soaking in a 10% NaOH solution for 30 min, rinsing with deionized water, and drying in airflow with the compressor. At temperature of 22° C. and relative humidity of 55% the obtained LLC solution was applied onto the glass panel surface with a Gardner® wired stainless steel rod #14, which was moved at a linear velocity of about 10 mm/s. The optical film was dried with a flow of the compressed air. The drying was not accompanied with any temperature treatment and took no more than several minutes.

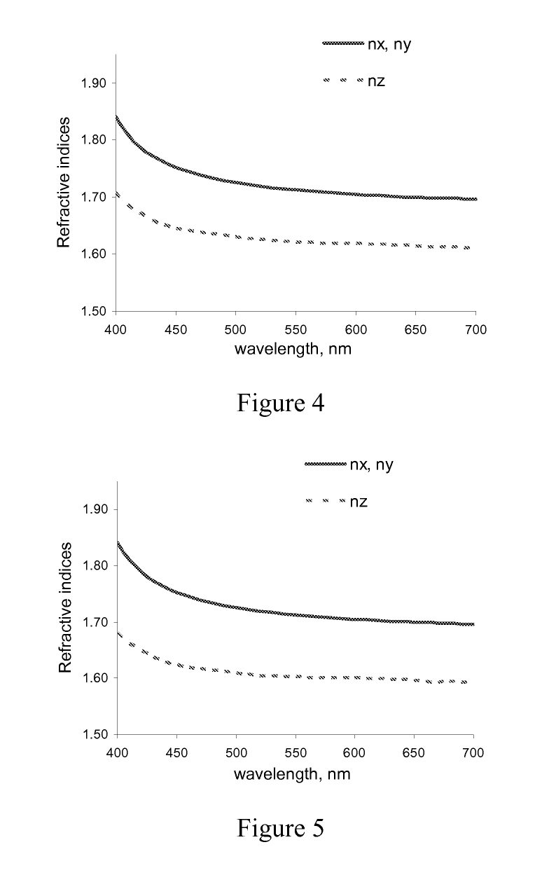

In order to determine the optical characteristics of the solid optical retardation layer, transmission and reflection spectra were measured in a wavelength range from 400 to 700 nm using and Cary 500 Scan spectrophotometer. Optical transmission and reflection of the retardation layer was measured using light beams linearly polarized parallel and perpendicular to the coating direction (Tₚₐᵣ and Tₚₑᵣ, respectively). The obtained data were used for calculation of the in-plane refractive indices (nₓ and n_{y}). Optical retardation spectra at different incident angles were measured in a wavelength range from 400 to 700 nm using Axometrics Axoscan Mueller Matrix spectropolarimeter, and out-of-plane refractive index (n_{z}) was calculated using these data and the results of the physical thickness measurements using Dectak³ST electromechanical profilometer. The obtained solid optical retardation layer was characterized by the thickness equal to approximately 750 nm and the principle refractive indices, which obey the following condition: n_{z}<n_{y}≈nₓ. Out-of-plane birefringence equals to 0.09. The principal refractive indices spectral dispersion is shown in FIG. 4.

### Example 6

Example 6 describes preparation of a solid optical retardation layer of negative C-type with 2,2′-disulfo-4,4′-benzidine terephthalamide-isophthalamide copolymer (terephthalamide/isophthalamide molar ratio 50:50) prepared as described in Example 2.

2 g of poly(2,2′-disulfo-4,4′-benzidine terephthalamide-isophthalamide copolymer) cesium salt produced as described in Example 2a was dissolved in 100 g of de-ionized water (conductivity ˜5 μm/cm). The suspension was mixed with a magnet stirrer. After dissolving, the solution was filtered with the hydrophilic filter with a 45 μm pore size and evaporated to the viscous isotropic solution of the concentration of solids of about 6%.

The coatings were produced and optically characterized, as was described in Example 5. The refractive indices spectral dependences are presented in FIG. 5. The obtained solid optical retardation layer is characterized by thickness equal to approximately 800 nm and the principle refractive indices which obey the following condition: n_{z}<n_{y}≈nₓ. Out-of-plane birefringence equals to 0.11.

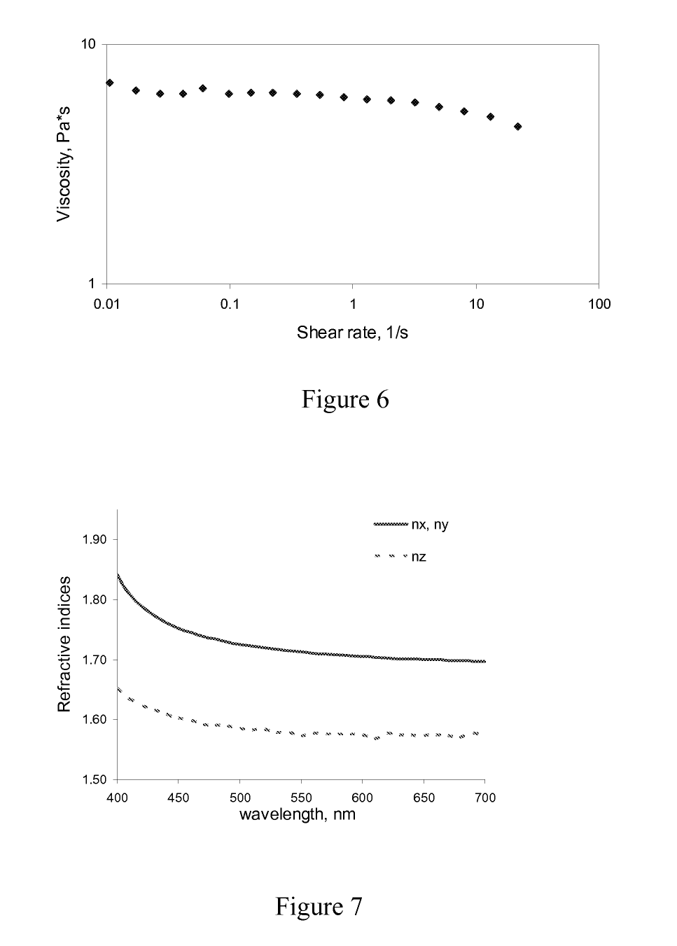

FIG. 6 shows the viscosity vs. shear rate dependence of the solution measured using stress-controlled AR 550 rheometer. Measurements were performed at 25° C. Cone-and-plate geometry (cone diameter=60 mm, gap=2° was used.

### Example 7

Example 7 describes preparation of a solid optical retardation layer of negative C-type with 2,2′-disulfo-4,4′-benzidine terephthalamide-isophthalamide copolymer (terephthalamide/isophthalamide molar ratio 75:25) prepared as described in Example 2.

2 g of poly(2,2′-disulfo-4,4′-benzidine terephthalamide-isophthalamide copolymer) cesium salt produced as described in Example 2b was dissolved in 100 g of de-ionized water (conductivity ˜5 μSm/cm). The suspension was mixed with a magnet stirrer. After dissolving, the solution was filtered with the hydrophilic filter with a 45 μm pore size and evaporated to the viscous isotropic solution of the concentration of solids of about 6%.

The coatings were produced and optically characterized as described in Example 5. The refractive indices spectral dependences are presented in FIG. 7. The obtained solid optical retardation layer is characterized by thickness equal to approximately 800 nm and the principle refractive indices which obey the following condition: n_{z}<n_{y}≈nₓ. Out-of-plane birefringence equals to 0.14.

### Example 8

Example 8 describes preparation of a solid optical retardation layer of Ac-plate type with 2,2′-disulfo-4,4′-benzidine terephthalamide-isophthalamide copolymer (terephthalamide/isophthalamide molar ratio 92:8) prepared as described in Example 2.

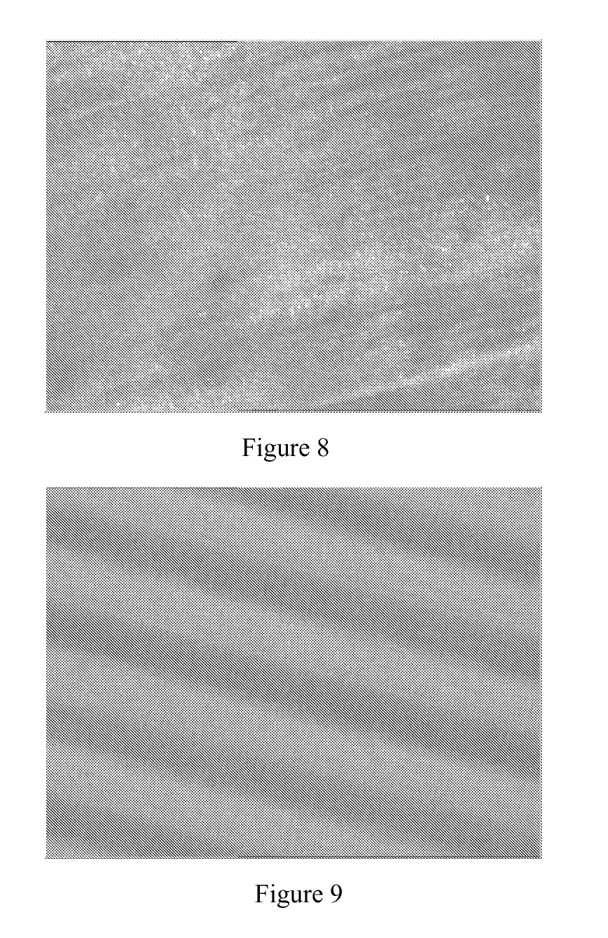

2 g of poly(2,2′-disulfo-4,4′-benzidine terephthalamide-isophthalamide copolymer) cesium salt produced as described in Example 2a was dissolved in 100 g of de-ionized water (conductivity ˜5 μSm/cm), and the suspension was mixed with a magnet stirrer. After dissolving, the solution was filtered with the hydrophilic filter of a 45 μm pore size and evaporated to form viscous birefringent solution of concentration of solids of approximately 6%. The polarized microscopy image of LLC solution is presented in FIG. 8.

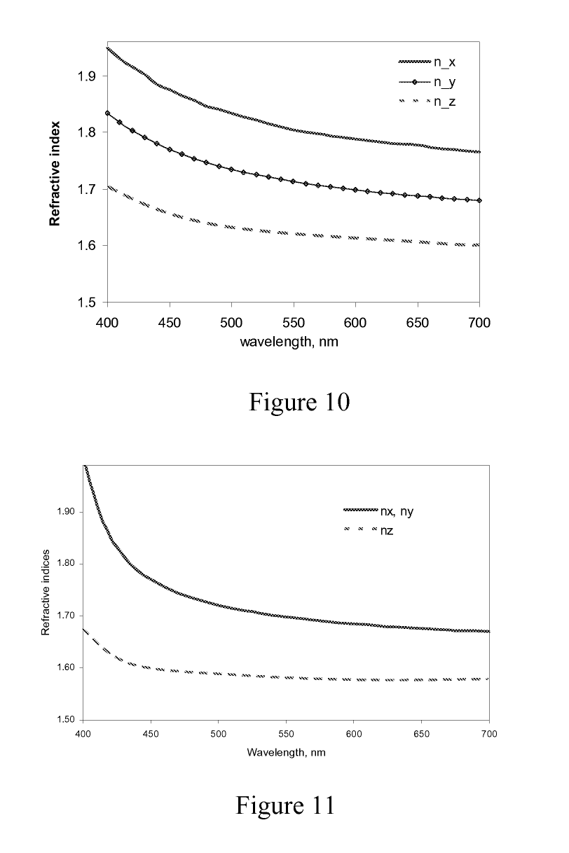

The coatings were produced and optically characterized as described in example 6, but the Mayer rod #8 was used. The polarized microscopy image of the optical film is presented in FIG. 9. The refractive indices spectral dependences are presented in FIG. 10. The obtained solid optical retardation layer is characterized by thickness of approximately 350 nm and the principle refractive indices which obey the condition: n_{z}<n_{y}<nₓ. NZ-factor equals to 2.0.

### Example 9

Example 9 describes of a solid optical retardation layer of negative C-type with poly(2,2′disulpho-4,4′benzidine 1,4,5,8-naphtalen tetracarboxylic acid diimid).

2 g of poly(2,2′disulpho-4,4′benzidine 1,4,5,8-naphtalen tetracarboxylic acid diimid) triethylammonium salt was dissolved in 50 g of dimethylsulfoxide, and the suspension was mixed with a magnet stirrer until complete dissolving.

The coatings were produced and optically characterized as described in Example 6. The obtained solid optical retardation layer is characterized by the thickness of approximately 500 nm and the principle refractive indices which obey the condition: n_{z}<n_{y}≈nₓ. Out-of-plane birefringence equals to 0.11.

### Example 10

Example 10 describes preparation of a solid optical retardation layer of negative C-type with poly(2,2′disulpho-4,4′benzidine 1,4,5,8-naphtalen tetracarboxylic acid diimid).

2 g of poly(2,2′disulpho-4,4′benzidine 1,4,5,8-naphtalen tetracarboxylic acid diimid) triethylammonium salt was dissolved in 100 g of 0.07% LiOH aqueous solution (pH˜11), and the suspension was mixed with a magnet stirrer. After dissolving, the solution was filtered with the hydrophilic filter of a 45 μm pore size and evaporated to the viscous isotropic solution of concentration of solids of approximately 4%.

The coatings were produced and optically characterized as described in Example 6. The obtained solid optical retardation layer is characterized by the thickness of approximately 500 nm and the principle refractive indices which obey the condition: n_{z}<n_{y}≈nₓ. The refractive indices spectral dependences are presented in FIG. 11. Out-of-plane birefringence equals to 0.11.

### Example 11

Example 11 describes preparation of a solid optical retardation layer of negative C-type with poly(2,2′-disulfo-4,4′-benzidine 1,3-dioxo-isoindoline-5-carboxamide).

2 g of poly(2,2′-disulfo-4,4′-benzidine 1,3-dioxo-isoindoline-5-carboxamide) cesium salt was dissolved in 100 g of de-ionized water (conductivity ˜5 μm/cm), and the suspension was mixed with a magnet stirrer. After dissolving, the solution was filtered with the hydrophilic filter of a 45 μm pore size and evaporated to the viscous isotropic solution of the concentration of solids of approximately 4%.

The coatings were produced and optically characterized as described in Example 6. The obtained solid optical retardation layer is characterized by the thickness of approximately 500 nm and the principle refractive indices which obey the condition: n_{z}<n_{y}≈nₓ. Out-of-plane birefringence equals to 0.11.

Although the present invention has been described in detail with reference to a particular preferred embodiment, persons possessing ordinary skill in the art to which this invention pertains will appreciate that various modifications and enhancements may be made without departing from the spirit and scope of the claims that follow.

What is claimed is:

1. An organic polymer compound of the general structural formula I: 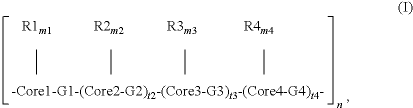
comprising n organic units,
where the organic unit comprises conjugated organic components Core1, Core2, Core3 and Core4 capable of forming a rigid rod-like macromolecule, G1, G2, G3 and G4 are spacers selected from the list comprising —C(O)—NH—, —NH—C(O)—, —N═(C(O))2=, —O—NH—, linear and branched (C1-C4)alkylenes, linear and branched (C1-C4)alkenylenes, —O—CH2-, —CH2-O—, —CH═CH—, —CH═CH—C(O)O—, —O(O)C—CH═CH—, —C(O)—CH2-, —OC(O)—O—, —OC(O)—, —C≡C—, —C(O)S—, —S—, —S—C(O)—, —O—, —NH—, —N(CH3)-;
R1, R2, R3 and R4 are lyophilic side-groups providing solubility to the organic polymer compound or its salts in a suitable solvent and which are the same or different and independently selected from the list comprising —COOH, —SO₃H, and —H₂PO₃ for water or water-miscible solvent, and linear and branched (C1-C20)alkyl, (C2-C20)alkenyl, and (C2-C20)alkinyl for organic solvent;
m1, m2, m3 and m4 are numbers of the lyophilic side-groups R1, R2, R3 and R4 in the conjugated organic components Core1, Core2, Core3 and Core4 respectively, which sum m=m1+m2+m3+m4 is equal to 0, 1, 2, 3, 4, 5, 6, 7, or 8; and
t2, t3 and t4 are numbers which are independently selected between 0 and 1,
wherein a solution of the organic polymer compound is capable of forming a solid optical retardation layer of a negative C-type or Ac-type plate substantially transparent to electromagnetic radiation in the visible spectral range.

2. An organic polymer according to claim 1, wherein the organic components Core1, Core2, Core3 and Core4 provide linearity and rigidity of the macromolecule, and the organic components, the lyophilic side groups and the number of the organic units control a ratio between mesogenic properties and viscosity of the solution.

3. An organic polymer compound according to claim 1, wherein the number n is an integer in the range from 5 to 1000.

4. An organic polymer compound according to claim 1, wherein the organic units are the same.

5. An organic polymer compound according to claim 1, wherein at least one said organic unit is different.

6. An organic polymer compound according to claim 1, wherein the organic components Core1, Core2, Core3 and Core4 are having general structural formulas independently selected from the list comprising general formulas II to VIII: 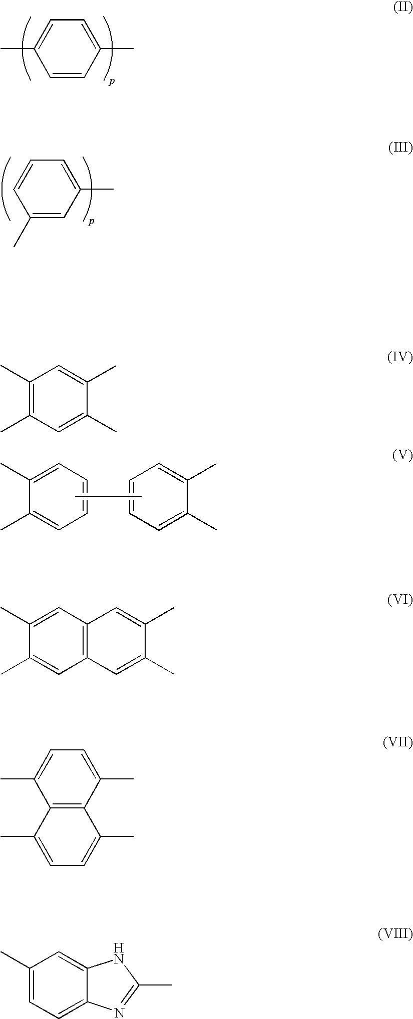
where p is equal to 1, 2, 3, 4, 5 or 6.

7. An organic polymer compound according to claim 1, having a structural formula I, where t₂ is equal to 1, t₃=t₄=0, m1=0 and m2=2; the organic component Core1 is selected from the general formulas II, III, where p=1, V, VII and VIII; the organic component Core2 has the general formula II, where p=2, the lyophilic side-group R2 is sulfo-group SO₃H; the spacer G1 is selected from the list comprising —C(O)—NH— and =2(C(O))═N—; and the spacer G2 is selected from the list comprising —C(O)—, —NH—C(O)—, —N═(C(O))2=; and wherein the organic polymer compound is selected from the structural formulas 1 to 6: 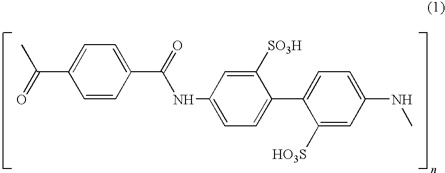
poly(2,2′-disulfo-4,4′-benzidine terephthalamide) 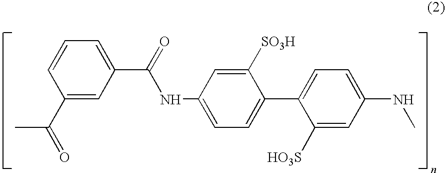
poly(2,2′-disulfo-4,4′-benzidine isophthalamide) 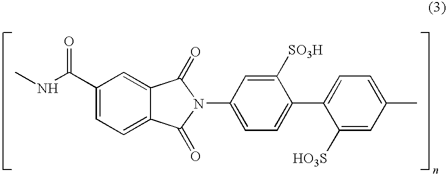
poly(2,2′-disulfo-4,4′-benzidine 1,3-dioxo-isoindoline-5-carboxamide) 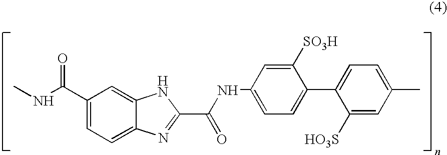
poly(2,2′-disulfo-4,4′-benzidine 1H-benzimidazole-2,5-dicarboxamide) 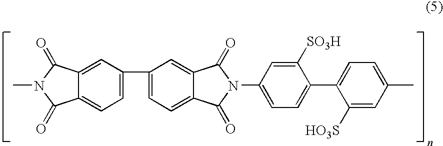
poly(2,2′-disulfo-4,4′-benzidine 3,3′,4,4′-biphenyl tetracarboxylic acid diimide) 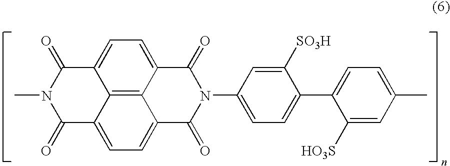
poly(2,2′disulpho-4,4′ benzidine 1,4,5,8-naphtalen tetracarboxylic acid diimide).

8. An organic polymer compound according to claim 1, wherein the salt of the organic polymer compound is selected from the list comprising alkaline metal salts, ammonium and alkyl-substituted ammonium salts.

9. An organic polymer compound according to claim 1, wherein the solvent is selected from the list comprising water, alkaline aqueous solutions, dimethylsulfoxide, dimethylformamide, dimethylacetamide, tetrahydrofurane, dioxane, and combination thereof.

10. An optical film comprising:
a substrate having front and rear surfaces, and
at least one solid optical retardation layer on the front surface of the substrate,
wherein the solid optical retardation layer comprises
at least one organic polymer compound of the general structural formula I: 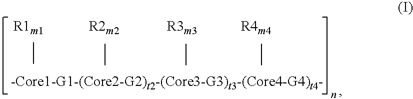
comprising n organic units,
where the organic unit comprises conjugated organic components Core1, Core2, Core3 and Core4 capable of forming a rigid rod-like macromolecule, G1, G2, G3 and G4 are spacers selected from the list comprising —C(O)—NH—, —NH—C(O)—, —N═(C(O))2=, —O—NH—, linear and branched (C1-C4)alkylenes, linear and branched (C1-C4)alkenylenes, —O—CH2-, —CH₂—O—, —CH═CH—, —CH═CH—C(O)O—, —O(O)C—CH═CH—, —C(O)—CH2-, —OC(O)—O—, —OC(O)—, —C≡C—, —C(O)—S—, —S—, —S—C(O)—, —O—, —NH—, —N(CH3)-;
R1, R2, R3 and R4 are lyophilic side-groups providing solubility to the organic polymer compound or its salts in a suitable solvent and which are the same or different and independently selected from the list comprising —COOM, —SO₃M, —HMPO₃ and -M₂PO₃ for water or water-miscible solvent where counterion M is selected from a list comprising H⁺, Na⁺, K⁺, Li⁺, Cs⁺, Ba²⁺Ca²⁺, Mg²⁺, Sr²⁺, Pb²⁺, Zn²⁺, La³⁺, Ce³⁺, Y³⁺, Yb³⁺, Gd³⁺, Zr⁴⁺ and NH₄₋ₖQₖ⁺ where Q is independently selected from the list comprising linear and branched (C1-C20) alkyl, (C2-C20)alkenyl, (C2-C20)alkinyl, and (C6-C20)arylalkyl, and k is 0, 1, 2, 3 or 4;
m1, m2, m3 and m4 are numbers of the lyophilic side-groups R1, R2, R3 and R4 in the conjugated organic components Core1, Core2, Core3 and Core4 respectively which sum m=m1+m2+m3+m4 is equal to 0, 1, 2, 3, 4, 5, 6, 7, or 8; and
t2, t3 and t4 are numbers which are independently selected between 0 and 1; and
wherein the solid optical retardation layer is a negative C-type or Ac-type plate substantially transparent to electromagnetic radiation in the visible spectral range.

11. An optical film according to claim 10, wherein the retardation layer type and birefringence are determined by rigidity and length of the rod-like macromolecules.

12. An optical film according to claim 10, wherein the number n is an integer in the range from 5 to 1000.

13. An optical film according to claim 10, wherein the organic units are the same.

14. An optical film according to claim 10, wherein at least one said organic unit is different from others.

15. An optical film according to claim 10, wherein the organic components Core1, Core2, Core3 and Core4 are having general structural formulas independently selected from the list comprising general formulas II to VIII: 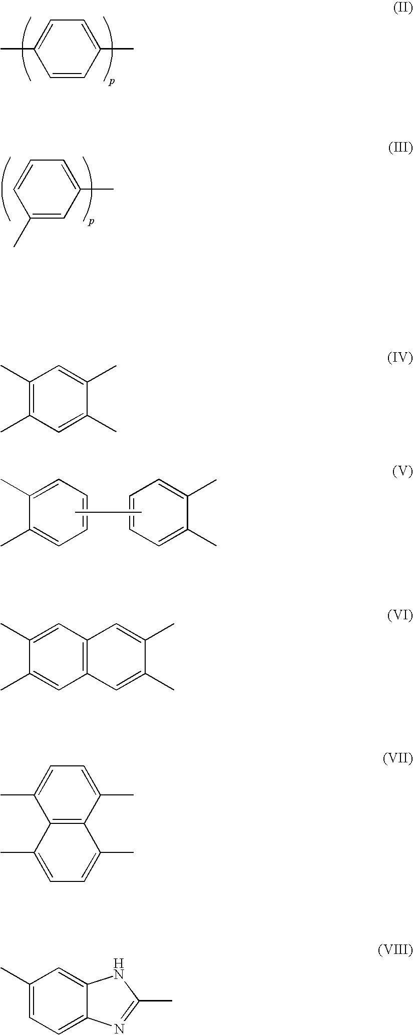
where p is equal to 1, 2, 3, 4, 5 or 6.

16. An optical film according to claim 10, wherein the organic polymer compound has a structural formula I, where t₂ is equal to 1, t₃=t₄=0, m1=0 and m2=2; the organic component Core1 is selected from the general formulas II, III, where p=I, V, VII and VIII; the organic component Core2 has the general formula II, where p=2, the lyophilic side-group R2 is sulfo-group SO₃H; the spacer G1 is selected from the list comprising —C(O)—NH— and =2(C(O))═N—; and the spacer G2 is selected from the list comprising —C(O)—, —NH—C(O)—, —N═(C(O))2=; and wherein the organic polymer compound is selected from the structural formulas 1 to 6: 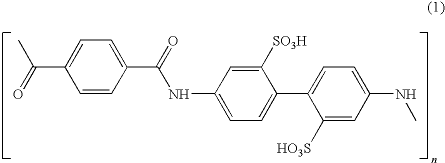
poly(2,2′-disulfo-4,4′-benzidine terephthalamide) 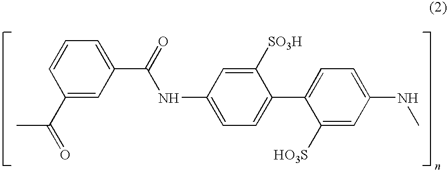
poly(2,2′-disulfo-4,4′-benzidine isophthalamide) 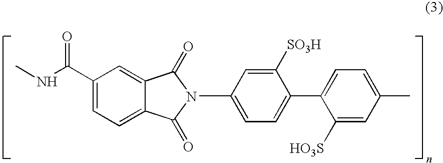
poly(2,2′-disulfo-4,4′-benzidine 1,3-dioxo-isoindoline-5-carboxamide) 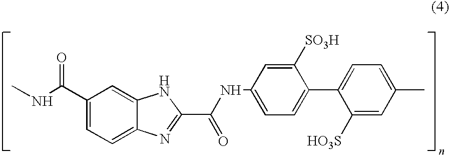
poly(2,2′-disulfo-4,4′-benzidine 1H-benzimidazole-2,5-dicarboxamide) 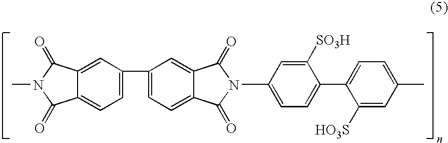
poly(2,2′-disulfo-4,4′-benzidine 3,3′,4,4′-biphenyl tetracarboxylic acid diimide) 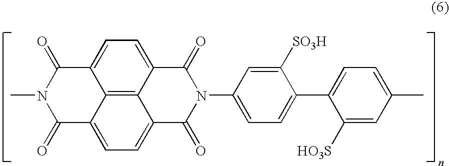
poly(2,2′disulpho-4,4′benzidine 1,4,5,8-naphtalen tetracarboxylic acid diimide).

17. An optical film according to claim 10, wherein the salt of the organic polymer compound is selected from the list comprising alkaline metal salts, triethylammonium salt and ammonium salt.

18. An optical film according to claim 10, further comprising inorganic compounds which are selected from the list comprising hydroxides and salts of alkaline metals.

19. An optical film according to claim 10, wherein said solid retardation layer is an uniaxial retardation layer possessing two refractive indices (nₓ and n_{y}) corresponding to two mutually perpendicular directions in the plane of the substrate and one refractive index (n_{z}) in the normal direction to the plane of the substrate, and wherein the refractive indices obey the following condition: n_{z}<nₓ=n_{y}.

20. An optical film according to claim 10, wherein said solid retardation layer is a biaxial retardation layer possessing two refractive indices (nₓ and n_{y}) corresponding to two mutually perpendicular directions in the plane of the substrate and one refractive index (n_{z}) in the normal direction to the plane of the substrate, and wherein the refractive indices obey the condition: n_{z}<n_{y}<nₓ.

21. An optical film according to claim 10, wherein the substrate material is selected from the list comprising polymer and glass.

22. A method of producing an optical film, comprising the steps of
a) preparation of a solution of an organic polymer compound of a general structural formula I or a salt thereof: 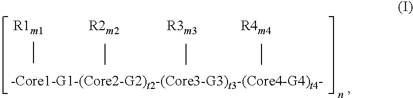
comprising n organic units,
where the organic unit comprises conjugated organic components Core1, Core2, Core3 and Core4 capable of forming a rigid rod-like macromolecule, G1, G2, G3 and G4 are spacers selected from the list comprising —C(O)—NH—, —NH—C(O)—, —N═(C(O))2=, —O—NH—, linear and branched (C1-C4)alkylenes, linear and branched (C1-C4)alkenylenes, —O—CH2-, —CH2-O—, —CH═CH—, —CH═CH—C(O)O—, —O(O)C—CH═CH—, —C(O)—CH₂—, —OC(O)—O—, —OC(O)—, —C≡C—, —C(O)S—, —S—, —S—C(O)—, —O—, —NH—, —N(CH3)-;
R1, R2, R3 and R4 are lyophilic side-groups providing solubility to the organic polymer compound or its salts in a suitable solvent and which are the same or different and independently selected from the list comprising —COOH, —SO₃H, and —H₂PO₃ for water or water-miscible solvent, and linear and branched (C1-C20)alkyl, (C2-C20)alkenyl, and (C2-C20)alkinyl for organic solvent;
m1, m2, m3 and m4 are numbers of the lyophilic side-groups R1, R2, R3 and R4 in the conjugated organic components Core1, Core2, Core3 and Core4 respectively which sum m=m1+m2+m3+m4 is equal to 0, 1, 2, 3, 4, 5, 6, 7, or 8; and
t2, t3 and t4 are numbers which are independently selected between 0 and 1, and
b) application of a liquid layer of the solution onto a substrate,
wherein the liquid layer is substantially transparent for electromagnetic radiation in the visible spectral range; and
c) drying to form a solid optical retardation layer,
wherein during the drying step a viscosity of the solution increases without mesophase formation.

23. A method according to claim 22, wherein the organic components Core1, Core2, Core3 and Core4 provide linearity and rigidity of the macromolecule, and the organic components, the lyophilic side groups and the number of the organic units control a ratio between mesogenic properties and viscosity of the solution.

24. A method according to claim 22, wherein the number n is an integer in the range from 5 to 1000.

25. A method according to claim 22, wherein the organic units are the same.

26. A method according to claim 22, wherein at least one organic unit is different from others.

27. A method according to claim 22, wherein the organic components Core1, Core2, Core3 and Core4 are having general structural formulas independently selected from the list comprising general formulas II to VIII: 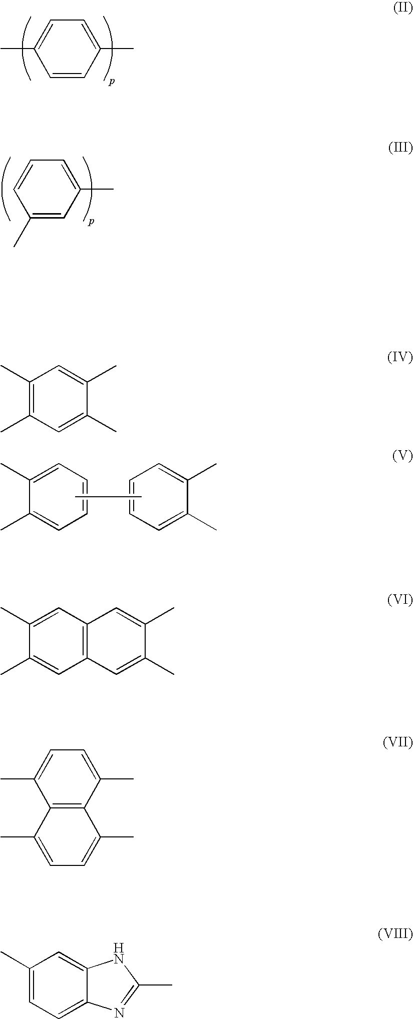
where p is equal to 1, 2, 3, 4, 5 or 6.

28. A method according to claim 22, wherein the organic polymer compound has a structural formula I, where t₂ is equal to 1, t₃=t₄=0, m1=0 and m2=2; the organic component Core1 is selected from the general formulas II, III, where p=I, V, VII and VIII; the organic component Core2 has the general formula II, where p=2, the lyophilic side-group R2 is sulfo-group SO₃H; the spacer G1 is selected from the list comprising C(O)—NH— and =2(C(O))═N—; and the spacer G2 is selected from the list comprising —C(O)—, —NH—C(O)—, —N═(C(O))2=; and wherein the organic polymer compound is selected from the structural formulas 1 to 6: 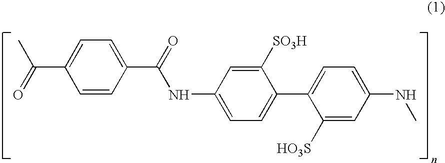
poly(2,2′-disulfo-4,4′-benzidine terephthalamide) 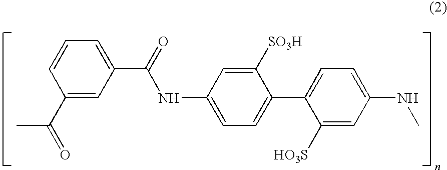
poly(2,2′-disulfo-4,4′-benzidine isophthalamide) 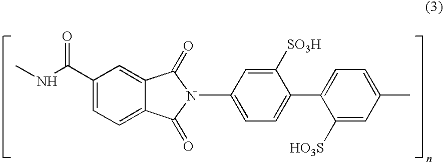
poly(2,2′-disulfo-4,4′-benzidine 1,3-dioxo-isoindoline-5-carboxamide) 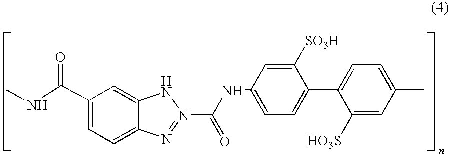
poly(2,2′-disulfo-4,4′-benzidine 1H-benzimidazole-2,5-dicarboxamide) 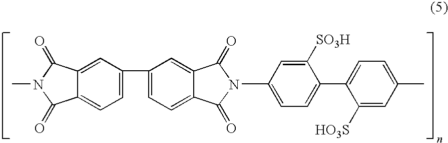
poly(2,2′-disulfo-4,4′-benzidine 3,3′,4,4′-biphenyl tetracarboxylic acid diimide) 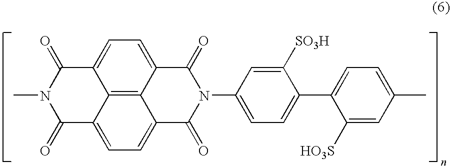
poly(2,2′ disulpho-4,4′benzidine 1,4,5,8-naphtalen tetracarboxylic acid diimide).

29. A method according to claim 22, wherein the salt is selected from the list comprising alkaline metal salts, triethylammonium salt and ammonium salt.

30. A method according to claim 22, wherein the substrate material is selected from the list comprising polymer and glass.

31. A method according to claim 22, further comprising a post-treatment step comprising a treatment with a solution of any aqueous-soluble inorganic salt with a cation selected from the list comprising H⁺, Ba²⁺, Pb²⁺, Ca²⁺, Mg²⁺, Sr²⁺, La³⁺, Zn²⁺, Zr⁴⁺, Ce³⁺, Y³⁺, Yb³⁺, Gd³⁺ and any combination thereof.

32. A method according to claim 22, wherein the solvent is selected from the list comprising water, alkaline aqueous solutions, dimethylsulfoxide, dimethylformamide, dimethylacetamide, tetrahydrofurane, dioxane, and combination thereof.

33. A method according to claim 22, wherein the application step is carried out using a coating technique selected from the list comprising Mayer rod, slot die, extrusion, roll coating, knife coating, spray-coating, printing and molding.

34. A method according to claim 22, wherein the sequence of the steps is repeated two or more times, and the solution used in the fabrication of each subsequent solid retardation layer is either the same or different from that used in the previous sequence of the steps.
